(19) United States
(12) Patent Application Publication
(10) Pub. No.: US 2015/0049303 A1
(43) Pub. Date: Feb. 19, 2015

(54) Photochromic Composite Lens

(71) Applicants: Wang Lee Chen Chang, Rende Township (TW); Po-Ling Shiao, Zhudong Township (TW); Mei-Chun Lai, Zhudong Township (TW)

(72) Inventors: Wang Lee Chen Chang, Rende Township (TW); Po-Ling Shiao, Zhudong Township (TW); Mei-Chun Lai, Zhudong Township (TW)

(21) Appl. No.: 13/969,655

(22) Filed: Aug. 19, 2013

(51) Int. Cl. G02C 7/10; B29D 11/00

(52) U.S. Cl. CPC G02C 7/102; B29D 11/00009; B29D 11/00413; B29K 2069/00
USPC 351/159.61; 264/1.7

(57) ABSTRACT

The present invention provides a photochromic composite lens which includes a penetration layer located exteriorly, and a blocking layer located interiorly, and a transition layer located between the penetration layer and the blocking layer. A thickness of the transition layer can be adjusted in view of the field requirements. In addition, functional coatings, such as abrasive-proof coating, fog-free coating, refraction free coating, and other functional coatings can be coated onto the penetration layer and the blocking layer, respectively. With this, the photochromic composite lens can be configured by polycarbonate lens or lens made from other material. Scratches over the surfaces will not impair the intended function of transition.

### BACKGROUND OF THE INVENTION

1. Technical Field

The present invention relates to a photochromic composite lens, and specially to a photochromic composite lens configured with lamination of different layers such that the thickness of a transition layer can be readily adjusted in view of the requirements so as to readily be applied in the polycarbonate lens or photochromic lens made from preset material. In addition, scratches on the photochromic composite lens will not impair the intended function of transition. This can effectively resolve the prior art manufacturing issues, and upgrade the flexibility in adjusting the thickness of the photochromic composite lens.

2. Description of Related Art

Currently, the existing photochromic lens is made from depositing a photochromic coating across the lens. Accordingly, the intended thickness of the photochromic coating is difficult to achieve. As a result, the transition of the color has always fail to meet the requirement, and sometimes, an uneven coating can be encountered. Even a hardening layer is coated over the photochromic layer, once the lens is suffered with scratches, fading can readily become an issue. Some other issues include, if the thickness or the concentration of the photochromic layer is too thick or high, then an oversaturated situation will be incurred. This is not amicable for economic production. On the other hand, the oversaturation will also impair the transition of the color, light to dark, and vice versa. Basically, most of the photochromic lens changes its color when ultraviolet light is passing through. However, the lens made from polycarbonate is generally includes a layer of UV barrier which will slow down the transition of the color.

The principle of color transition of the currently available photochromic lens can be categorized into the followings. Firstly, the photochromic lens is made from material which changes color. A certain element is mixed with the material used to make the lens. Accordingly, even the lens is suffered with scratches; the function of transition is still intact without being impaired. On the other hand, the transition of color is satisfactory even across the lens and last longer. However, if this kind of material is used to make the corrective lens, then the concave or convex of the lens will create an unevenness of the color. On the other hand, some of the material, such as the polycarbonate which has to undergo a comparative high temperature which in turn will impair the photochromic material contained therein. Accordingly, the polycarbonate material can not be used in this first category. Secondly, depositing a photochromic coating over the lens entertains a good transition of color as well as satisfactory durability. However, once the lens is scratched, there would be an obvious defective portion where the color will not be changed.

### BRIEF SUMMARY OF THE INVENTION

The present invention is to provide a substantial improvement to the manufacturing of the existing photochromic lens by providing an improved photochromic lens configured by lamination of composite lens layers such that the thickness of a transition layer can be readily adjusted in view of the requirements so as to readily be applied in the polycarbonate lens or photochromic lens made from preset material. In addition, scratches on the photochromic composite lens will not impair the intended function of transition. This can effectively resolve the prior art manufacturing issues, and upgrade the flexibility in adjusting the thickness of the photochromic composite lens.

The primary purpose of the present invention is to provide an improved photochromic composite lens which comprises a front lens layer located at outside and which allows high ultraviolet light or short wavelength light penetrating capability, and a rear lens layer located at inside and which has capability of blocking high ultraviolet light or short wavelength light penetration; a transition layer between the high ultraviolet light or short wavelength light penetrating layer and the blocking high ultraviolet light or short wavelength light layer. The thickness of the transition layer can be readily adjusted according to field requirement. Functional coatings, such as of hardening coating, anti-fogging coating, and anti-reflection coating or other functional coatings can be readily coated over the front surface of the front lens layer, and the rear surface of the rear lens layer. Accordingly, the photochromic lens configured therefrom can be readily applied to the photochromic lens made from polycarbonate material or other preset material lens. In addition, scratches on the photochromic composite lens will not impair the intended function of transition.

It is a second purpose of the present invention to provide a method for making photochromic lens, and includes the following steps. Disposing a penetrating layer of high ultraviolet light or short wavelength light penetrating capability into a preset supporting fixture, and then administering a preset amount of transition liquid paste onto the penetrating layer, and then disposing a blocking layer having capability of blocking high ultraviolet light or short wavelength light penetration disposed onto the penetrating layer so as to evenly distribute the transition liquid paste between the penetrating layer and the blocking layer. Wherein the ultraviolet light blocking layer is integrally formed with dowels located on the sides and with adequate height such that the dowels stand onto the corresponding surface of the penetrating layer of ultraviolet light so as to properly create the transition layer. Then, the assembly is undergone a curing process with heat or light, and the portion located between dowels of the ultraviolet light blocking layer is trimmed down. The assembly is further undergone a surface treatment so as to apply a hardening coating on the outer surface of ultraviolet light and other short wavelength light penetrating layer, and the inner surface of the ultraviolet light blocking layer so as to configure a photochromic lens made from polycarbonate or other preset material.

According to the third object of the present invention is to provide a pair of dowels located on extensions on the ends of an inner side of the ultraviolet light and other short wavelength light blocking layer. The height of the dowels can be readily adjusted according to the thickness of the transition layer.

According to the fourth object of the present invention, a method for making a photochromic lens in accordance with a second embodiment includes the following steps. Disposing a penetrating layer of high ultraviolet light or short wavelength light penetrating capability into a preset supporting fixture. Forming horizontal portions on longitudinal ends of the penetrating layer of high ultraviolet light or short wavelength light penetrating capability. Then administering a preset amount of transition liquid paste onto the penetrating layer of high ultraviolet light or short wavelength light penetrating capability. Forming supporting parts on a horizontal portion extending from sides of a blocking layer having capability of blocking high ultraviolet light or short wavelength light penetration such that the supporting parts stand onto the horizontal portions of the penetrating layer of high ultraviolet light or short wavelength light penetrating capability so as to create a gap of preset thickness to allow the transition liquid paste evenly distributing between the penetrating layer of high ultraviolet light or short wavelength light penetrating capability and the blocking layer having capability of blocking high ultraviolet light or short wavelength light penetration, and create a transition layer. Then, the assembly is undergone a curing process with heat or light, and the preset portion formed on the assembly is trimmed down. The assembly is further undergone a surface treatment so as to apply a functional coatings, such as hardening coating, anti-fogging coating, anti-reflection coating or other functional coating on the outer surface of ultraviolet light and other short wavelength light penetrating layer, and the inner surface of the ultraviolet light blocking layer so as to configure a photochromic lens made from polycarbonate or other preset material.

According to the fifth object of the present invention, a method for making a photochromic lens in accordance with a third embodiment includes the following steps. Disposing a penetrating layer of high ultraviolet light or short wavelength light penetrating capability into a preset supporting fixture which is provided with supporting dowels around the peripheral. Then administering a preset amount of transition liquid paste onto the penetrating layer of high ultraviolet light or short wavelength light penetrating capability. Defining aligning hole on a horizontal portion extending from sides of a blocking layer having capability of blocking high ultraviolet light or short wavelength light penetration such that the aligning holes match with the dowels of the preset supporting fixture so as to create a gap of preset thickness to allow the transition liquid paste evenly distributing between the penetrating layer of high ultraviolet light or short wavelength light penetrating capability and the blocking layer having capability of blocking high ultraviolet light or short wavelength light penetration, and create a transition layer. Then, the assembly is undergone a curing process, and the assembly is trimmed down along the preset area. The assembly is further undergone a surface treatment so as to apply a functional coatings, such as hardening coating, anti-fogging coating, anti-reflection coating or other functional coating on the outer surface of ultraviolet light and other short wavelength light penetrating layer, and the inner surface of the ultraviolet light blocking layer so as to configure a photochromic lens made from polycarbonate or other preset material.

### BRIEF DESCRIPTION OF THE SEVERAL VIEWS OF THE DRAWINGS

FIG. 1 is an illustration of a photochromic lens in use;

FIG. 2 illustrates step 1 of a method for making photochromic lens made in accordance with a first embodiment of the present invention;

FIG. 3 illustrates step 2 of a method for making photochromic lens made in accordance with a first embodiment of the present invention;

FIG. 4 illustrates step 3 of a method for making photochromic lens made in accordance with a first embodiment of the present invention;

FIG. 5 illustrates step 4 of a method for making photochromic lens made in accordance with a first embodiment of the present invention;

FIG. 6 illustrates step 5 of a method for making photochromic lens made in accordance with a first embodiment of the present invention;

FIG. 7 illustrates step 1 of a method for making photochromic lens made in accordance with second embodiment of the present invention;

FIG. 8 illustrates step 2 of a method for making photochromic lens made in accordance with second embodiment of the present invention

FIG. 9 illustrates step 3 of a method for making photochromic lens made in accordance with second embodiment of the present invention;

FIG. 10 is a top view of step 1 of a method for making photochromic lens made in accordance with third embodiment of the present invention;

FIG. 11 illustrates step 1 of a method for making photochromic lens made in accordance with third embodiment of the present invention;

FIG. 12 illustrates step 2 of a method for making photochromic lens made in accordance with third embodiment of the present invention; and

FIG. 13 illustrates step 3 of a method for making photochromic lens made in accordance with third embodiment of the present invention.

### DETAILED DESCRIPTION OF THE INVENTION

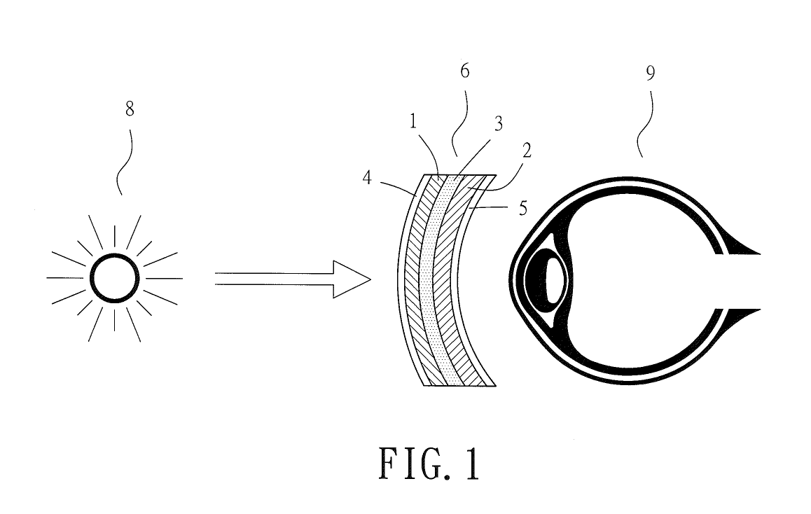

The improved photochromic composite lens and method for making it, such as shown in FIG. 1, provides a photochromic lens 6 which comprises a front lens layer 1 located at outside and which allows high ultraviolet light or short wavelength light penetrating capability, and a rear lens layer 2 located at inside and which has capability of blocking high ultraviolet light or short wavelength light penetration; a transition layer 3 between the high ultraviolet light or short wavelength light penetrating layer and the blocking high ultraviolet light or short wavelength light layer. The thickness of the transition layer 3 can be readily adjusted according to field requirement. Functional coatings 4, 5, such as of hardening coating, anti-fogging coating, and anti-reflection coating or other functional coatings can be readily coated over the front surface of the front lens layer, and the rear surface of the rear lens layer. Accordingly, the photochromic lens configured therefrom can be readily applied to the photochromic lens made from polycarbonate material or other preset material lens. In addition, scratches on the photochromic composite lens 6 will not impair the intended function of transition.

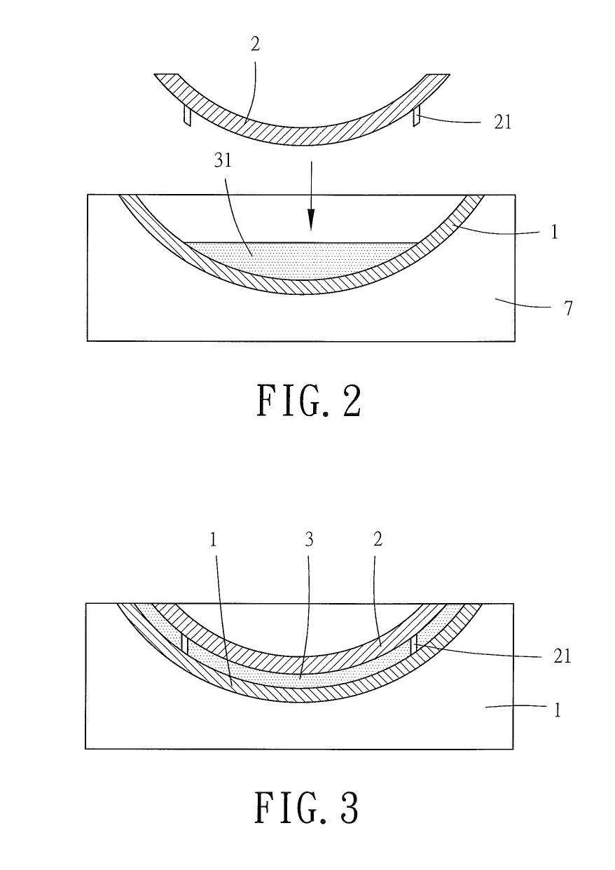

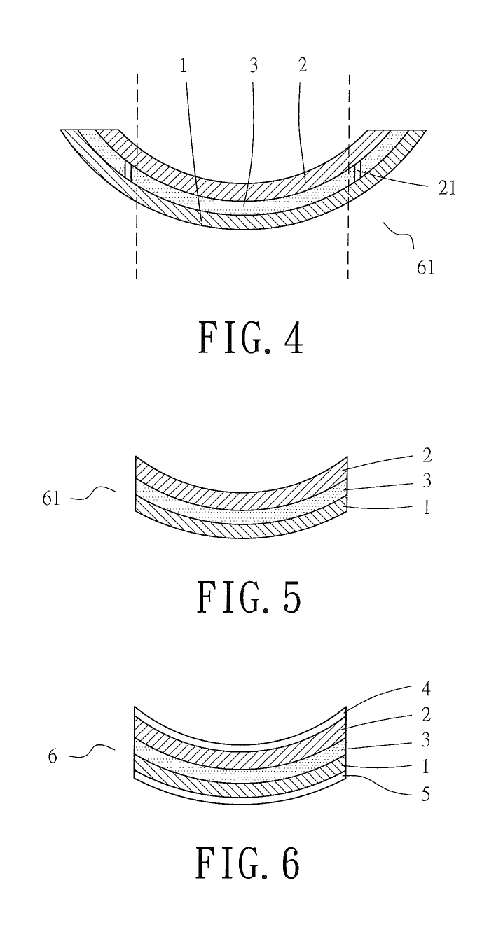

The method for making the photochromic lens 6 includes the following steps. Disposing a penetrating layer 1 of high ultraviolet light or short wavelength light penetrating capability into a preset supporting fixture 7, see FIG. 2. Then administering a preset amount of transition liquid paste 31 onto the penetrating layer 1, and then disposing a blocking layer 2 having capability of blocking high ultraviolet light or short wavelength light penetration disposed onto the penetrating layer 1 so as to evenly distribute the transition liquid paste 31 between the penetrating layer 1 and the blocking layer 2 to create the transition layer 3. Wherein the ultraviolet light blocking layer 2 is integrally formed with dowels 21 located on the sides and with adequate height facing downward such that the dowels stand onto the corresponding surface of the penetrating layer 1 of ultraviolet light so as to properly create the transition layer 3, see FIG. 3. See so as to evenly distribute the transition liquid paste 31 between the penetrating layer 1 and the blocking layer 2). Then, the assembly 61 is undergone a curing process with heat or light, and the portion located between the dowels 21 of the ultraviolet light and other short wavelength blocking layer 2 is trimmed down, see FIGS. 4 and 5. The assembly 61 is further undergone a surface treatment so as to apply a hardening coating 4, 5, such as of hardening coating, anti-fogging coating, and anti-reflection coating or other functional coatings, respectively, on the outer surface of ultraviolet light and other short wavelength light penetrating layer 1, and the inner surface of the ultraviolet light blocking layer 2 so as to configure a photochromic lens made from polycarbonate or other preset material, see FIG. 6.

Regarding to the dowels 21 located on extensions on the ends of an inner side of the ultraviolet light and other short wavelength light blocking layer 2 of the photochromic lens 6, the height of the dowels 21 can be readily adjusted according to the thickness of the transition layer 3 of the photochromic lens 6.

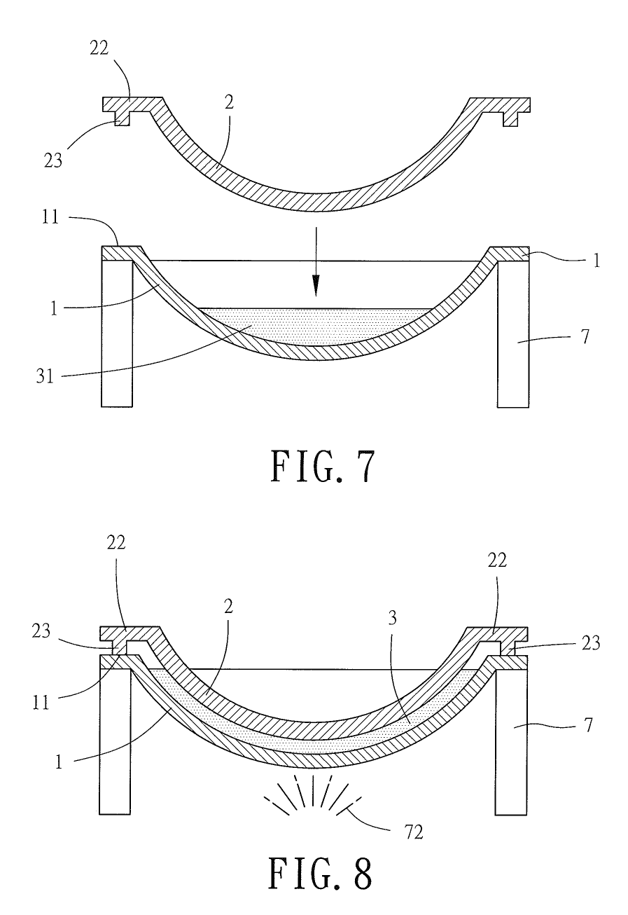

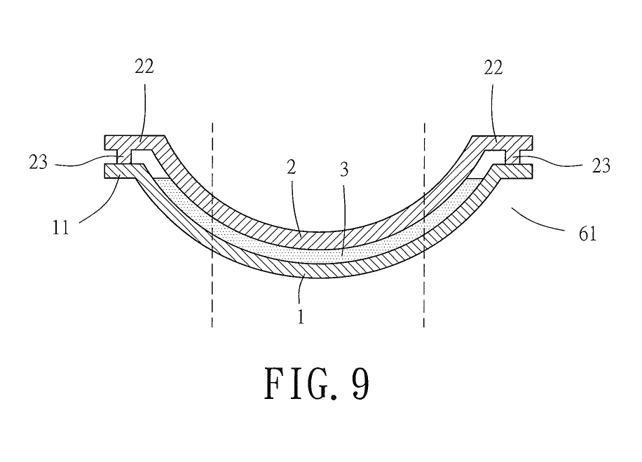

A method for making a photochromic lens in accordance with a second embodiment includes the following steps. Disposing a penetrating layer 1 of high ultraviolet light or short wavelength light penetrating capability into a preset supporting fixture 7, see FIG. 7. Forming horizontal portions 11 on longitudinal ends of the penetrating layer 1 of high ultraviolet light or short wavelength light penetrating capability. Then administering a preset amount of transition liquid paste 31 onto the penetrating layer 1 of high ultraviolet light or short wavelength light penetrating capability. Forming supporting parts 23 on a horizontal portion 22 extending from sides of a blocking layer 2 having capability of blocking high ultraviolet light or short wavelength light penetration such that the supporting parts 23 stand onto the horizontal portions 11 of the penetrating layer 1 of high ultraviolet light or short wavelength light penetrating capability, see FIG. 8, so as to create a gap of preset thickness to allow the transition liquid paste 31 evenly distributing between the penetrating layer 1 of high ultraviolet light or short wavelength light penetrating capability and the blocking layer 2 having capability of blocking high ultraviolet light or short wavelength light penetration, and create a transition layer 3. Then, the assembly 61 is undergone a curing process with light 72, and the preset portion formed on the assembly is trimmed down, see FIG. 9. The assembly 61 is further undergone a surface treatment so as to apply a functional coatings 4, 5, such as hardening coating, anti-fogging coating, anti-reflection coating or other functional coating on the outer surface of ultraviolet light and other short wavelength light penetrating layer 1, and the inner surface of the ultraviolet light blocking layer 2 so as to configure a photochromic lens made from polycarbonate or other preset material, see FIG. 6.

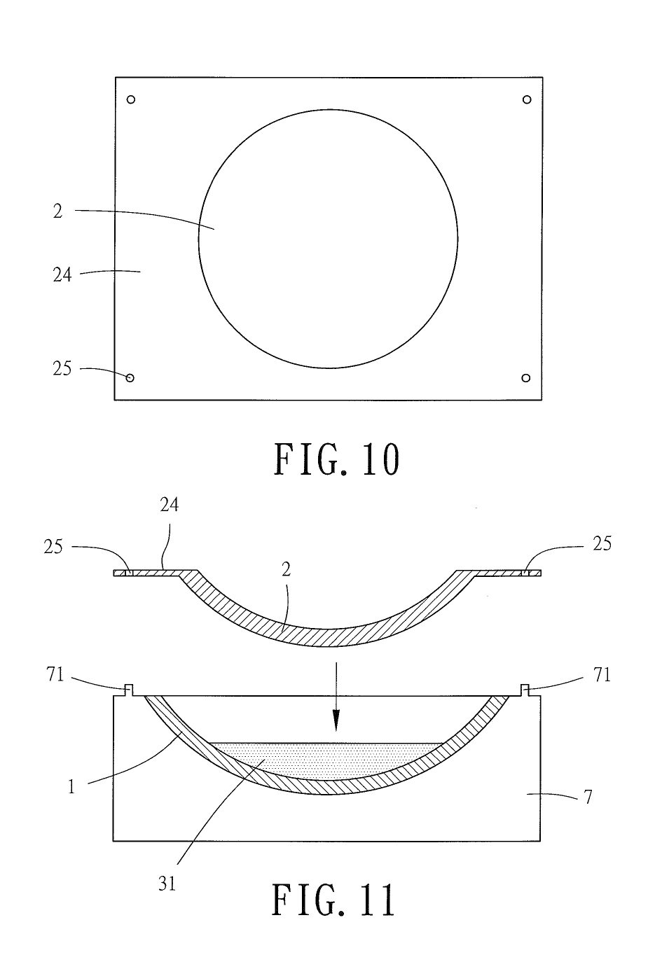

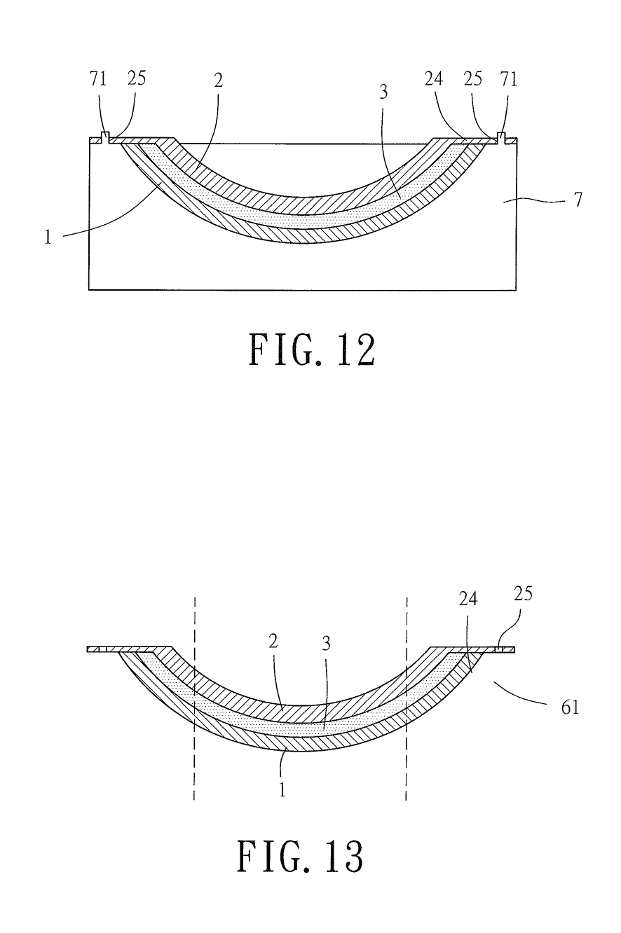

A method for making a photochromic lens in accordance with a second embodiment includes the following steps. Disposing a penetrating layer 1 of high ultraviolet light or short wavelength light penetrating capability into a preset supporting fixture 7, see FIG. 11, and which is provided with supporting dowels 71 around the peripheral, see FIGS. 10, 11. Then administering a preset amount of transition liquid paste 31 onto the penetrating layer 1 of high ultraviolet light or short wavelength light penetrating capability. Defining aligning hole 25 on a horizontal portion 24 extending from sides of a blocking layer 2 having capability of blocking high ultraviolet light or short wavelength light penetration such that the aligning holes 25 match with the dowels 71 of the preset supporting fixture 7, see FIG. 12, so as to create a gap of preset thickness to allow the transition liquid paste 31 evenly distributing between the penetrating layer 1 of high ultraviolet light or short wavelength light penetrating capability and the blocking layer 2 having capability of blocking high ultraviolet light or short wavelength light penetration, and create a transition layer 3 by curing the supporting fixture 7. Then, the assembly 61 is undergone a curing process, and the assembly 61 is trimmed down along the preset area, see FIG. 13. The assembly 61 is further undergone a surface treatment so as to apply a functional coatings 4, 5, see FIG. 6, such as hardening coating, anti-fogging coating, anti-reflection coating or other functional coating on the outer surface of ultraviolet light and other short wavelength light penetrating layer 1, and the inner surface of the ultraviolet light blocking layer 2 so as to configure a photochromic lens 6 made from polycarbonate or other preset material.

Regarding to the photochromic lens 6, see FIG. 1, the penetrating layer 1 is made from material having high ultraviolet light or short wavelength light penetrating capability such that the adjacent transition layer 3 can be readily triggered to change its color. However, the blocking layer 2 is made from material having capability of blocking high ultraviolet light or short wavelength light penetration. Accordingly, the ultraviolet light from sunshine 8 will not reach into the eyes 9 which can be properly protected accordingly. This photochromic lens 6 is configured with the penetrating layer 1 is made from material having high ultraviolet light or short wavelength light penetrating capability and the blocking layer 2 is made from material having capability of blocking high ultraviolet light or short wavelength light penetration through positioning or engagement so as to provide the transition layer 3 with even thickness. By this arrangement, the manufacturing issue of prior art photochromic lens can be readily resolved, and upgrade the dynamic adjustment of the thickness of the photochromic lens.

What is claimed is:

1. A photochromic composite lens, comprising:
a front lens layer located at outside, and a rear lens layer located at inside, a transition layer of photochromic dye sandwiched between the front and rear lens layers;
a supporting structure arranged between the front and really layers so as to create an even space in which the transition layer is filled therein; and
functional coatings being applied to the front lens layer and the rear lens layer, respectively.

2. The photochromic composite lens as recited in claim 1, wherein the front lens layer is a penetration layer in which the ultraviolet light or light of short wavelength can penetrate, while the rear lens layer is a block layer in which the ultraviolet light and other short wavelength will be blocked.

3. The photochromic composite lens as recited in claim 1, wherein the supporting structure is curved dowels with fixed height in conform to the curvature of the lens layers.

4. The photochromic composite lens as recited in claim 1, wherein the supporting structure is configured with an extended plane and an alignment dowel with a fixed height corresponding to the extending plane.

5. The photochromic composite lens as recited in claim 1, wherein the supporting structure is facilitated with an extended plane of the front lens layer in alignment with the rear lens layer.

6. The photochromic composite lens as recited in claim 1, wherein the transition layer ranges from 10-200 μm.

7. The photochromic composite lens as recited in claim 1, wherein the transition layer ranges from 20-150 μm.

8. The photochromic composite lens as recited in claim 1, wherein the transition layer ranges from 30-100 μm.

9. The photochromic composite lens as recited in claim 1, wherein the front and rear lens layers can be selected from one of the Polycarbonate (PC), Polymethylmethacrylic (PMMA), MasterCast1 or MasterrCast 2, CR-39, allyl diglycol carbonate resin, Polyethylene terephathalate (PET), Polyvinyl Alcohol (PVA), Nylon, and cycloolefin polymer, respectively.

10. The photochromic composite lens as recited in claim 1, wherein a carrier of the transition layer is polymer, and selected from one of the polyurethane- base, polyurea urethane-base, poly(meth)acrylic-base, aminoplast, epoxy-base polymer, ethyleneglycol bismethacrylate polymer, ethoxylated phenol bismethactrlate polymer, urethane acrylate polymer, polythiourethane polymer, cellulose acetate butyrate (CAB), styrene polymer, or copoly(styrene-methyl methacrylate) polymer.

11. The photochromic composite lens as recited in claim 1, wherein the transition layer is made from photochromic material selected from naphthopyran, spiropyran, spirooxazine, chromene, fulgide, azobenzene, salicylidene aniline, etc.

12. The photochromic composite lens as recited in claim 1, wherein the functional coating applied to the front and rear lens layers includes the coating of hardening, anti-fogging, and anti-reflection.

13. A method for making photochromic composite lens, comprising the steps of:
forming a front lens having a layer allowing high ultraviolet light or short wavelength light penetrating capability;
forming a rear lens having a layer blocking high ultraviolet light or short wavelength light penetrating capability;
forming integrally a supporting structure simultaneously with the formation of the front and rear lens layers so as to define a space of with even thickness when the front and rear lens layers are laminated, wherein photochromic material can be filled into the space so as to create a transition layer;
placing the front lens layer onto a fixture with a concave surface facing upward and administering a certain amount of photochromic material;
placing the rear lens layer onto the front lens with a convex surface facing downward evenly distributing the photochromic material across the space defined between the front and rear lens layer;
curing the photochromic material of the transition layer; and
removing the photochromic composite lens from the fixture.

14. The method as recited in claim 13, wherein the fixture can be hollowed configuration or non-hollowed configuration.

15. The method as recited in claim 13, wherein the curing of the photochromic material can be facilitated by heat or radiation.

16. The method as recited in claim 15, wherein the radiation is ultraviolet light.

17. The method as recited in claim 16, wherein the ultraviolet light is located in front of the front lens layer, and the photochromic material is cured after the ultraviolet light penetrate through the front lens layer.

18. The method as recited in claim 13, wherein the alignment between the front and rear lens layers can be facilitated by mechanical alignment or by dowels of rear lens layer.

19. The method as recited in claim 13, wherein the front and rear lens layers of the photochromic composite lens can be further coated with functional plating or coating.
